(19) United States
(12) Patent Application Publication
(10) Pub. No.: US 2016/0366750 A1
(43) Pub. Date: Dec. 15, 2016

(54) GLOVE LIGHTING CONTROLLER

(71) Applicant: Jonathan Tzeng, San Diego, CA (US)

(72) Inventor: Jonathan Tzeng, San Diego, CA (US)

(21) Appl. No.: 14/739,589

(22) Filed: Jun. 15, 2015

(51) Int. Cl. H05B 37/02; F21V 33/00; H05B 33/08

(52) U.S. Cl. CPC H05B 37/0272; H05B 33/0854; H05B 33/0872; F21V 33/008

(57) ABSTRACT

A system for controlling lights for gloving has one or more microlights adapted to be mounted on a user's hands, a signal transmitter configured to transmit a signal to a signal receiver, and a portable device containing an application to control the light color, intensity and duration. Each microlight has a light configured to display a plurality of colors, a signal receiver, and a microcontroller to control the light. A method of programming a plurality of microlights includes the steps of: (1) assigning a unique identifier to each light to be programmed; (2) editing a profile by selecting one or more lights and one or more colors, durations and transitions of the light to program the lights; (3) previewing the colors, durations and transitions of the one or more lights; and (4) transmitting the profiles to individual lights such that the lights illuminate in accordance with the profile.

### BACKGROUND OF THE INVENTION

1. Field of Invention

This invention relates to controller for the lighting in glove tips for use in the “gloving” dance form.

2. Description of Related Art

Gloving is a dance form that has evolved in conjunction with the electronic music scene, wherein the dancer moves his hands in a dark room, wherein the tips of the gloves are illuminated and leave trails. Gloving utilizes lights on the tips of fingers to create intricate movements and illusions. The lights on the fingertips usually consist of microlights (LED or other) secured to the tips of the fingers by fabric gloves. The microlights are similar to LED keychain flashlights that use coin cell batteries, but employ an RGB LED and can output various patterns of colors and blanks, creating colorful trails when in motion.

The gloving moves with the beat of the music. The tips of the fingers are illuminated with LEDs. It is desirable to control the parameters of the LEDs, including coordinating color, brightness, and changing colors to complement the music and entertain the viewer.

In the prior art, the lights may controlled individually, wherein each light is programmed individually using an interface mounted on the light, such as a pushbutton. A series of pushes in a complex sequence provides choice of color and flashing. Each light has a controller thereon and an interface consisting of a button. Programming lights individually through a crude user interface involving a single button is time consuming and awkward, and users are unable to share their light settings electronically.

Also in the prior art is a central programming interface with wired connection to each of the lights, wherein the wires feed through the glove's fingers to the lights, and the lights may be programmed in a pattern by use of the central interface. The central interface is also awkward to program and use, and must be piggybacked on the gloves, resulting in a bulkier glove. The wires reduce the longevity of the gloves, being additional points of failure, and the prior art lacks the ability for the users to share light settings.

There is a need in the art for a remote, wireless smartphone or computer-enabled programming system for gloving lights.

### SUMMARY OF THE INVENTION

The present invention overcomes these and other deficiencies of the prior art by providing a way to wirelessly program all gloving lights simultaneously, a smartphone or computer application to provide an intuitive method of programming lights, and an online community to facilitate sharing of light patterns and settings.

A system for controlling lights for gloving has one or more microlights adapted to be mounted on a user's hands, a signal transmitter configured to transmit a signal to a signal receiver, and a portable device containing an application to control the light color, intensity and duration. Each microlight has a light configured to display a plurality of colors, a signal receiver, and a microcontroller to control the light. The microcontroller is in communication with the light and the signal receiver, and the portable device is in communication with the signal receiver.

In an embodiment, the signal is an infrared signal. In a further embodiment, the signal is transmitted as an eight-character hexadecimal signal block, containing an indicator what the signal block is, a mode index, a duration value, an red, green and blue values configured to describe the color.

In an embodiment, the portable device is a smartphone.

In an embodiment, the light is a RGB LED.

In an embodiment, each microlight also has a button, and the application controls the light in response to one or more button presses. In a further embodiment, the application has (1) an interface configured to create a profile by selecting actions based on one or more button presses; (2) an interface configured to preview the profile; and (3) an interface for sharing a profile with other users.

In an embodiment, the microlight also has an accelerometer, and the application controls the light in response to accelerometer input. In a further embodiment, the application has: (1) an interface configured to create a profile by selecting actions based on accelerometer input; (2) an interface configured to preview the profile; and (3) an interface for sharing the profile with other users.

In an embodiment, the application has: (1) an interface configured to create a profile by selecting color, duration, intensity and transition for individual lights; (2) an interface configured to preview the color, duration and transition of the profile; and (3) an interface for sharing the profile with other users.

In an embodiment, the application transmits a profile to a plurality of microlights using the signal transmitter.

A method of programming a plurality of microlights includes the steps of: (1) assigning a unique identifier to each light to be programmed; (2) editing a profile by selecting one or more lights and one or more colors, durations and transitions of the light to program the lights; (3) previewing the colors, durations and transitions of the one or more lights; and (4) transmitting the profiles to individual lights such that the lights illuminate in accordance with the profile. In an embodiment, the method also includes the step of sharing the profile with a gloving community.

A method of programming a plurality of microlights includes the the steps of: (1) generating an initial identification number for each of the microlights; (2) selecting a program of light settings comprising RGB values, light pattern timing, duration and intensity; and (3) transmitting the light settings from the transmitter to a receiver for each of the microlights. In an embodiment, the method also includes the step of transmitting a termination signal when a transmission is complete. Alternatively, in another embodiment, the method also includes the step of error correcting the transmission to each of the microlights.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows the microlight with an onboard infrared receiver as well as the transmitter, according to an embodiment of the invention;

FIGS. 2a-f forms a composite schematic diagram of the application for controlling a gloveset, according to a present embodiment of the invention; and

FIG. 3 shows a method for programming microlights, according to an embodiment of the invention.

### DETAILED DESCRIPTION OF PREFERRED EMBODIMENTS

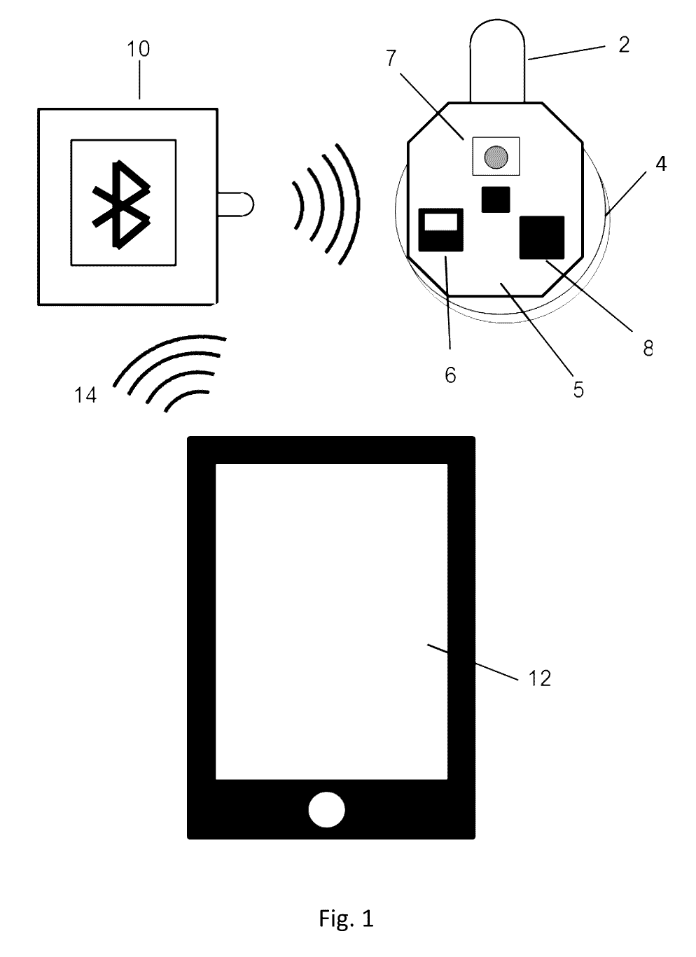

Preferred embodiments of the present invention and their advantages may be understood by referring to FIGS. 1 to 3 wherein like reference numerals refer to like elements.

FIG. 1 shows a microlight for installation into a glove's fingertip. The microlight has a light 2 (typically LED or other low-voltage lights), a battery 4 to power the light, and an infrared receiver 6 for the light to receive instructions on duration, intensity and/or color choice from an infrared transmitter. In an embodiment, the microlight also contains a microcontroller 8 to control the color, duration and intensity of the microlight. The components of the microlight may be mounted to a frame or circuit board 5, wherein the components are wired together. The microlight may contain a button 7 for interaction by the user, and may contain an accelerometer on the PCB to provide an accelerometer output regarding the movement of the microlight.

FIG. 1 also shows the infrared transmitter for connecting to a device 12 such as a smartphone, having a transmitter 10 part and an interface 14 (preferably Bluetooth or wired) for connection to the smartphone to receive instructions for the signals to transmit by infrared to the microlight. The transmitter 10 contains an internal battery (not shown) to power its functions. In an embodiment, the transmitter 10 is a Bluetooth programming module that communicates with the device 12 by Bluetooth. If designed to be continuously paired with, the infrared transmitter 10 requires no internal storage as the data storage is performed within the smartphone or computer.

In an embodiment the transmitter 10 is a standalone device that may receive programming by USB or Bluetooth into its memory, wherein an infrared signal may be transmitted at a later time without proximity to the device 12 (smartphone, for example). The transmitter provides instructions to the microlights by means of infrared transmission, wherein the microlights receive the transmission and are adapted to light up in accordance with the data contained in the transmission. In the standalone embodiment, the transmitter contains memory to store preferred lighting configurations.

The control program resides on the smartphone as an “app”, or within the standalone transmitter microcontroller, and enables a user to select different combinations of colors, duration and intensity of the lights.

In an embodiment, the light controller may take input from the beat of the music, wherein i) the beat is sensed directly by the microlight, ii) is sensed by the transmitter and beat information is transmitted to the microlight, and/or iii) is sensed using the phone microphone and transmitted through the transmitter to the microlight.

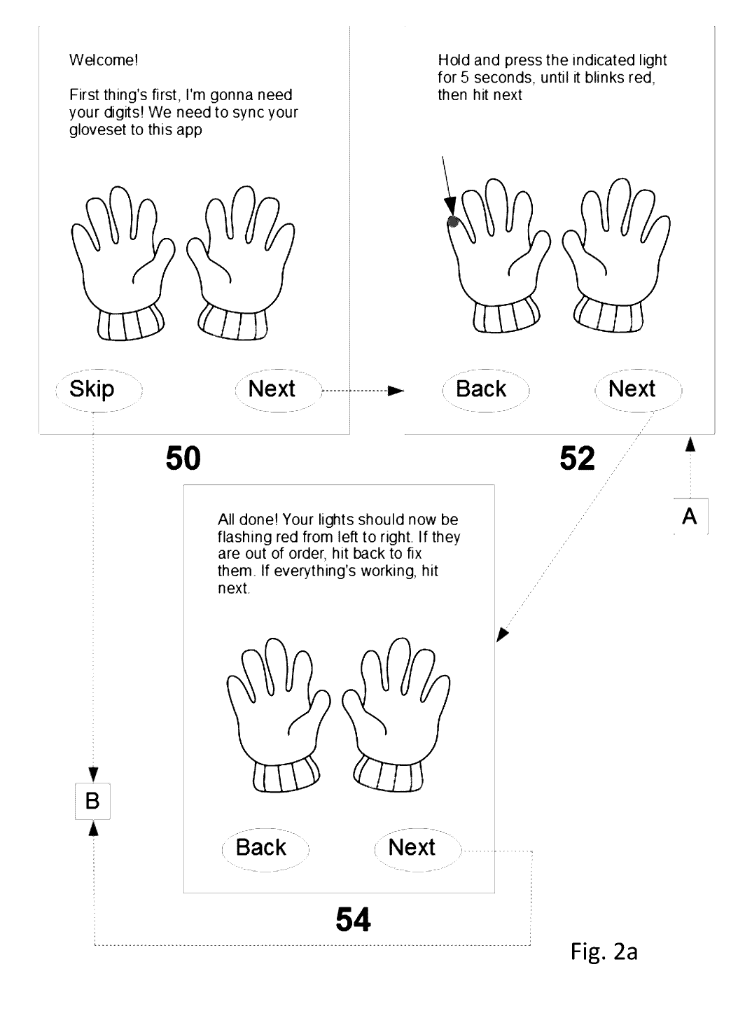

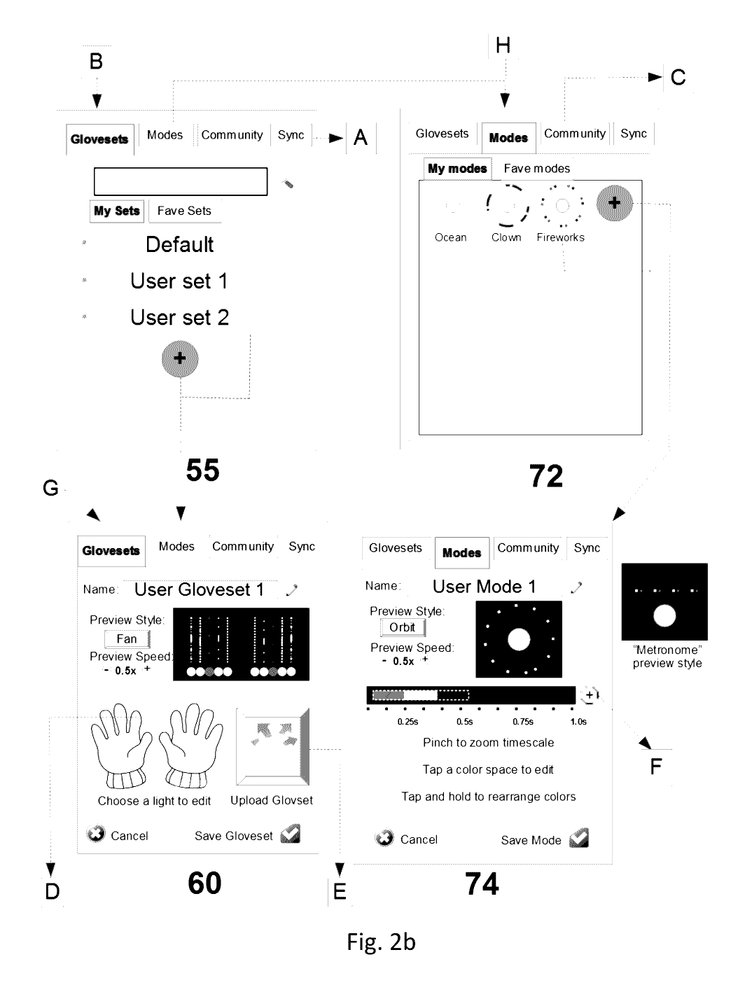

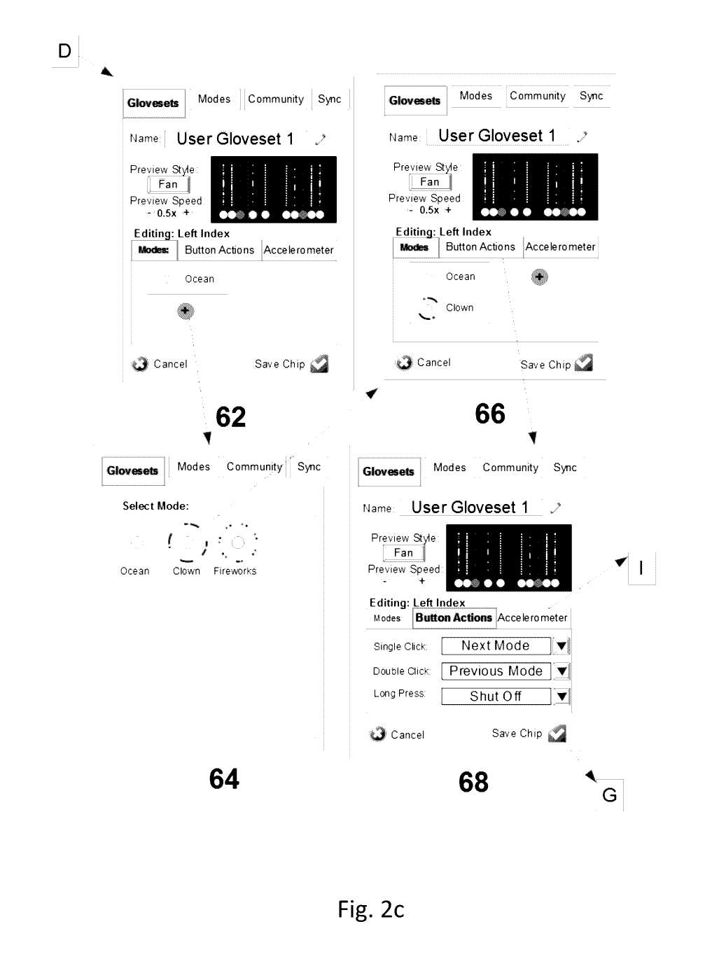

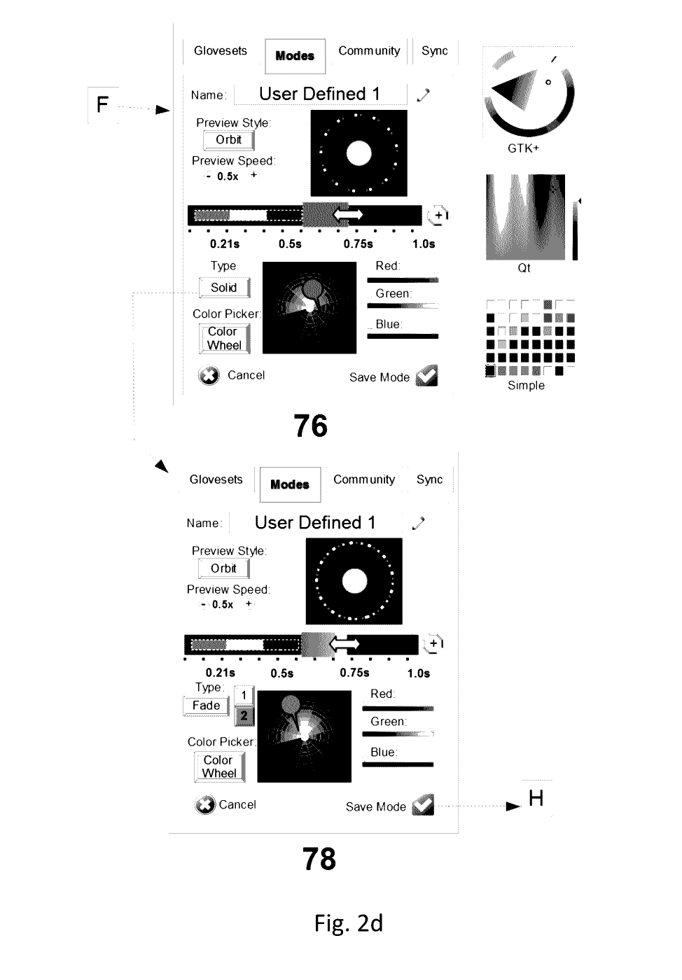

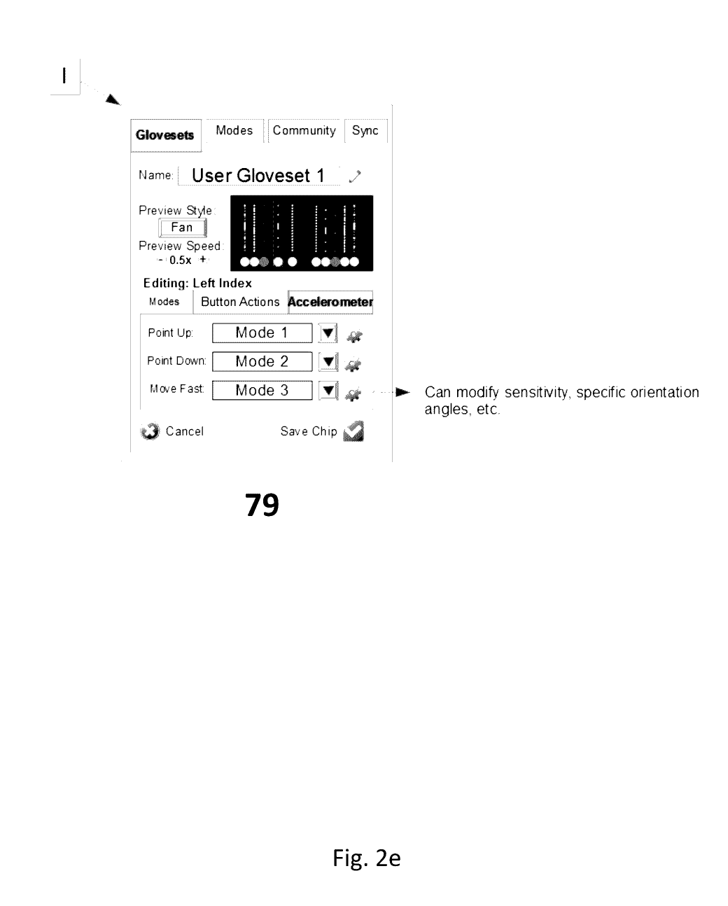

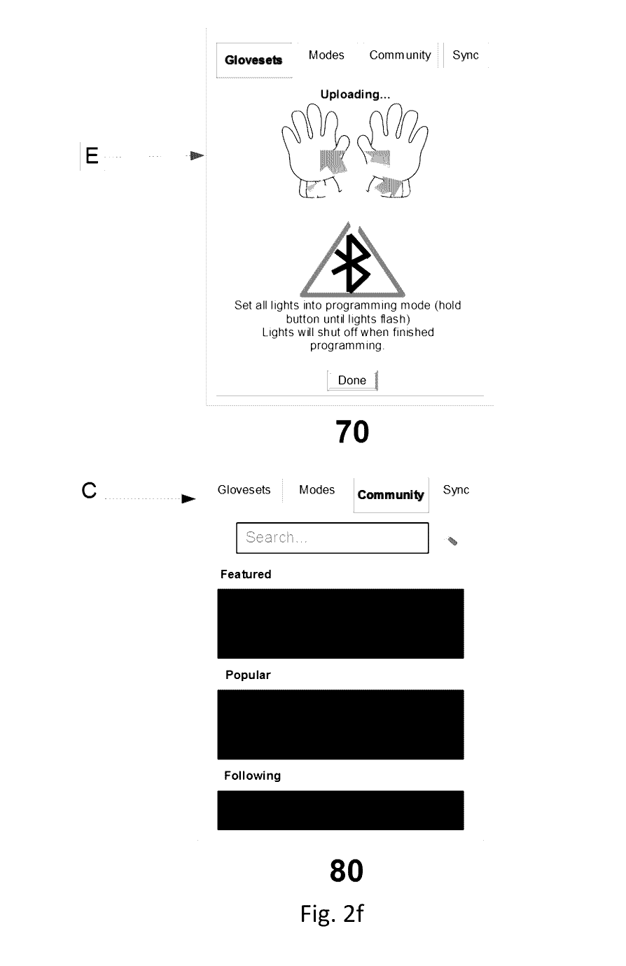

With reference to FIGS. 2a-f, an embodiment of the control program or “app” is shown. The control program enables a user to i) save color profiles and share color patterns for individual lights as well as entire glove sets through an online community, ii) choose colors, transitions and timing, wherein colors can be precisely determined from RGB levels, and transitions between colors can be set, for example a smooth color fade transition, and various lengths of on/off times, iii) view a light trail preview that displays what the selected settings would look like when the lights are in motion, iv) program button actions, wherein actions performed for length, number and sequence of button presses, in order to control, for example, color set increment/decrement, jump to a certain mode, and toggle lights on/off, and v) customize an auto shutdown timer to prevent drained batteries from light accidentally turned on or left on.

With reference to FIG. 2a-f, in step 50 a welcome screen is shown that enables that initializes the microlights and synchronizes them for programming. In step 52, one by one, buttons on the individual microlights are pressed by the user when prompted to by the program. An infrared signal containing the unique identifier is transmitted simultaneously with the prompt to press the button. In step 54, at the end of the initialization procedure, each of the microlights receives a unique identifier, and provides a notification when it has received this. In step 55, user can select a gloveset, which can be created, edited, saved and deleted. In step 60 the user begins editing a gloveset by tapping a finger on the glove. The user can preview the settings from a fan view, wherein lights wave up and down, a metronome, wherein lights wave side to side, and orbit wherein the lights orbit around a central point. Each of these preview settings include a static representation of the light so the user can gauge what mixed color the light would show when static. The preview may also include common gloving movements including finger rolls, whips and tunnels. In step 62, the user specifies the viewing mode (ocean, clown or fireworks, showing representations of the lights), color and duration in step 64, and users can rearrange the settings of each microlight in step 66. In step 68, the user can program button actions that are invoked, for example, by a single click, a double click and a long press of the button, while the microlight is illuminated. Users can also define actions that have parameters, such as “jump to mode X”, “auto switch modes after X time”, “double click delay” and “long press delay”. The user can also define a second set of actions taken on button push when the lights are off. The user can select “accelerometer” to customize the effects associated with accelerometer ouput. In step 70 the upload button is pushed and the settings are transmitted to the microlights. In an embodiment, the user touches the button on each of the microlights to enable sequential programming. In another embodiment, the microlights may be placed in programming mode without contact. In step 72, the mode is selected and the user can choose “my modes” or “fave modes”. In an embodiment the center dot shows the color animating in real time, while the outer circle animates the light in a slower motion with a visible trail. The modes can be edited, saved or deleted. In step 74, the user previews the modes using a preview style (Orbit or Metronome for example), and receives instructions for selecting the timescale and colors for the illumination for a microlight. In step 76, the user selects the color from a spectrum wheel or other representation of the color spectrum known in the art such as GTK+, Qt and Simple, and inserts it into the timescale. The user may program a series of colors and durations in this way for a particular microlight. The color may be a solid color or a fade; using a fade, the user selects the second color of the fade in step 78. In step 79, the effects resulting from accelerometer output are programmed, for example, the mode from a “point up” output indicating the microlight is pointing up, or a “point down” or “move fast” output. In step 80, the user enters the “Community” tab. A search is available that may have various filters and modes available, including search by Mode Glovesets, Users and Colors. Users have the ability to share their settings and programs, and can “favorite” sets that can be added to their device. Once selected, user can edit their favorites and save the edited versions to a list of their modes, and users can add other users to follow.

The infrared protocol is described, wherein the transmitter transmits several infrared signal blocks for every color space, configuration, mode and chip, repeatedly. It sends the information repeatedly to reduce the probability that any of the microlights do not receive their entire programming. The microlight completes its programming as a result of a constant timeout delay, or by receiving a block containing the amount of data that was sent, wherein the amount matches the data received by the microlight. The transmission stops when the user selects to stop the transmission on the control program. In an embodiment, a single infrared signal block sent from the transmitter is read by the microlight as a hexadecimal 0x81234567. In other embodiments, the data follows different patterns with different block lengths. The microlight's microcontroller parses the hexadecimal digits to determine data elements as follows:

| Data | Description |
|---|---|
| 8 (binary 1000) | True/False parameters, tells the chip what the |
| | signal block signifies. In an embodiment, it |
| | carries the data: |
| | this block is an identifier |
| | save or read the identifier |
| | fade to the next color |
| | last color space of the mode |
| 1 | Mode index. Defines in what order this mode |
| | will be placed on microlight microcontroller. |
| 234 | Duration value for this color space |
| 5 | R value for this color space |
| 6 | G value for this color space |
| 7 | B value for this color space |

The leftmost digit is read in binary to signify true/false, in the case of Hexadecimal 8 representing binary 1000, or 4 true/false 1/0 selections. In this example, the microcontroller expects the following data for these various binary bits from left to right: i) this block is an identifier (TRUE), ii)) save or read the identifier (FALSE=read), iii) fade to the next color (FALSE), and iv) the last color space of the mode (FALSE). In this case, the microcontroller will read the signal 0x81234567 as an identifier with the value “1234567”. If the microcontroller had previously saved an identifier value of “1234567”, it will begin saving subsequent signals until the last color space has been found.

To ensure the correct data has been received by the microlight microcontroller, the last block of data sent to a particular microlight includes an error checking signal containing the number of transmitted signals. If the number of transmitted signals matches the number of received signals, the microlight may flash in a completion status sequence and shut off or cease receiving signals. Otherwise, the microlight may continue flashing its LED in a manner indicating that it is still in programming mode. In one embodiment, the error checking signal is indicated by combining parameters that are normally mutually exclusive (i.e. not valid data occurrences) to describe further parameters. For example, “This block is an identifier” can be combined with “The last color space of the mode” to represent whether or not the signal is to be used for error checking The microcontroller understands that this combined signal is the error correcting signal containing the total number of transmitted signals.

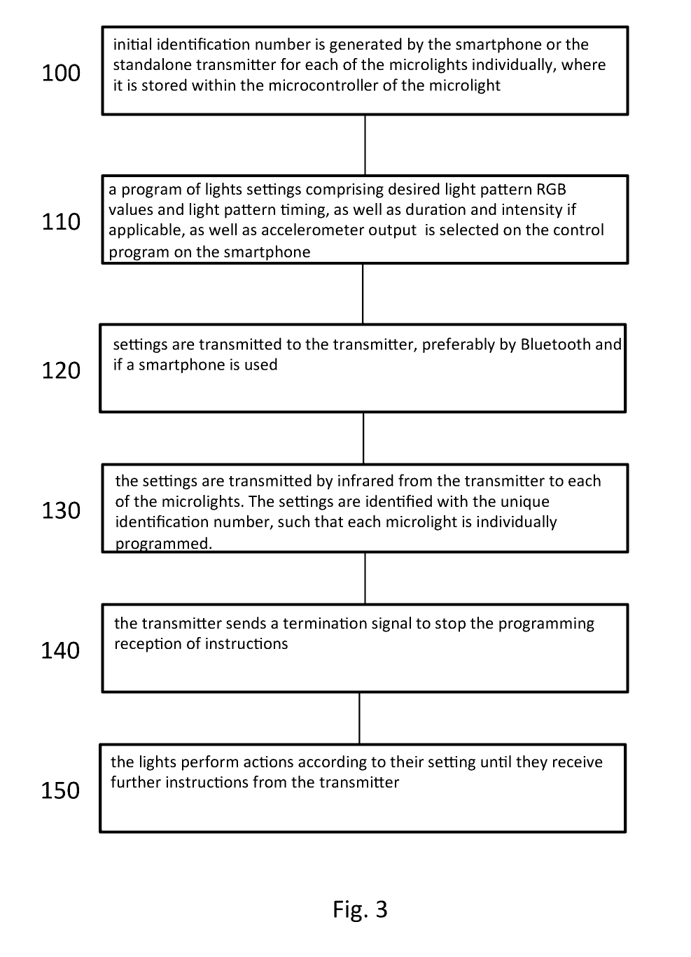

With reference to FIG. 3, users wish to set different settings, parameters and programs, employing color patterns, for the different lights at the tips of the fingers. In order to facilitate the simultaneous programming of the lights with the settings, a unique IR protocol is used. In step 100, an initial identification number is generated by the smartphone or the standalone transmitter for each of the microlights individually, where it is stored within the microcontroller of the microlight. The numbers may be randomly generated to reduce the possibility that the same number is in use nearby by a different user. In step 110, a program of lights settings comprising desired light pattern RGB values and light pattern timing, as well as duration and intensity, if applicable, is selected on the control program on the smartphone or standalone transmitter. The program may also determine colors and modes, as well as transitions, according to button press pattern or physical orientation of the microlight, as determined by an accelerometer. In step 120 the settings are transmitted to the transmitter, preferably by Bluetooth and if a smartphone is used. In step 130, the settings are transmitted by infrared from the transmitter to each of the microlights. The settings are identified with the unique identification number, such that each microlight is individually programmed. In an embodiment, the data is in the following form: [microlight 1 identification number], [configuration data], [microlight 2 identification number], [configuration data], [microlight 3 identification number], [configuration data] etc. Each of the microlights receives the same series of infrared data from the transmitter, but only starts recording settings once its identification number is detected. In step 140, the transmitter sends a termination signal to stop the programming reception of instructions. In step 150, the lights perform actions according to their setting until they receive further instructions from the transmitter.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for controlling lights for gloving, comprising:
a. one or more microlights adapted to be mounted on a user's hands, each microlight comprising;
i. a light configured to display a plurality of colors
ii. a signal receiver; and
iii. a microcontroller to control the light, wherein the microcontroller is in communication with the light and the signal receiver; and
b. a signal transmitter configured to transmit a signal to the signal receiver; and
c. a portable device containing an application to control the light color, intensity and duration, wherein the portable device is in communication with the signal receiver.

2. The system of claim 1, wherein the signal is an infrared signal.

3. The system of claim 1, wherein the portable device is a smartphone.

4. The system of claim 1, wherein the light is a RGB LED.

5. The system of claim 1, wherein each microlight further comprises a button and the application controls the light in response to one or more button presses.

6. The system of claim 1, wherein the microlight further comprises an accelerometer and the application controls the light in response to accelerometer input.

7. The system of claim 1, wherein the application comprises:
a. an interface configured to create a profile by selecting color, duration, intensity and transition for individual lights;
b. an interface configured to preview the color, duration and transition of the profile; and
c. an interface for sharing the profile with other users.

8. The system of claim 5, wherein the application comprises:
a. an interface configured to create a profile by selecting actions based on one or more button presses;
b. an interface configured to preview the profile; and
c. an interface for sharing a profile with other users.

9. The system of claim 6, wherein the application comprises:
a. an interface configured to create a profile by selecting actions based on accelerometer input;
b. an interface configured to preview the profile; and
c. an interface for sharing the profile with other users.

10. The system of claim 2, wherein the signal is transmitted as an eight- character hexadecimal signal block, containing an indicator what the signal block is, a mode index, a duration value, an red, green and blue values configured to describe the color.

11. The system of claim 1, wherein the application transmits a profile to a plurality of microlights using the signal transmitter.

12. A method of programming a plurality of microlights, comprising the steps of:
a. assigning a unique identifier to each light to be programmed;
b. editing a profile by selecting one or more lights and one or more colors, durations and transitions of the light to program the lights;
c. previewing the colors, durations and transitions of the one or more lights; and
d. transmitting the profiles to individual lights such that the lights illuminate in accordance with the profile.

13. The method of claim 12, further comprising the step of sharing the profile with a gloving community.

14. A method of programming a plurality of microlights, comprising the steps of:
a. generating an initial identification number for each of the microlights;
b. selecting a program of light settings comprising RGB values, light pattern timing, duration and intensity; and
c. transmitting the light settings from the transmitter to a receiver for each of the microlights.

15. The method of claim 14, further comprising the step of transmitting a termination signal when a transmission is complete.

16. The method of claim 14, further comprising the step of error correcting the transmission to each of the microlights.
